(19) United States
(12) Patent Application Publication
(10) Pub. No.: US 2012/0077529 A1
(43) Pub. Date: Mar. 29, 2012

(54) APPARATUS AND METHOD FOR UPDATING DATA IN PORTABLE TERMINAL

(75) Inventors: Jong-Seok Kim, Suwon-si (KR); Hyung-Jun Jeon, Seoul (KR)

(73) Assignee: SAMSUNG ELECTRONICS Co., LTD., Suwon-si (KR)

(21) Appl. No.: 13/249,029

(22) Filed: Sep. 29, 2011

(30) Foreign Application Priority Data
Sep. 29, 2010 (KR) 10-2010-0094061

(51) Int. Cl. H04W 4/14; H04W 4/12

(52) U.S. Cl. 455/466

(57) ABSTRACT

An apparatus and method update data in a portable terminal. The apparatus comprises a data update unit and a controller. The data unit is configured to manage information associated with the portable terminal and a request for an address book update transmitted from the portable terminal. The controller is configured to receive changed address book information from an update server that manages an address book of another portable terminal in response to the request transmitted by the data update unit.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Sep. 29, 2010 and assigned Serial No. 10-2010-0094061, the entire disclosure of which is hereby incorporated by reference.

### TECHNICAL FIELD OF THE INVENTION

The present invention relates to an apparatus and method for updating data in a portable terminal, and more particularly to an apparatus and method for automatically determining and storing personal information such as telephone numbers around a user, a notice, and an attached material and so forth in a portable terminal.

### BACKGROUND OF THE INVENTION

Recently, the portable terminal which is capable of wireless voice communication and exchanging information in accordance with developing mobile communication technologies has become an essential good. However, the early portable terminal can be simply carried and recognized to enable a user to the wireless communication. The portable terminal has been satisfied with the need of a user and the scope of use is getting wider. For example, the scope may include simple telephone communication, the scheduling management ad so forth, games, watching TV for the satellite broadcasting, a remote controller using a short-range communication, taking a photograph using a digital camera, as well as, introducing the mobile internet with related technology development.

However, people use by leaving a note such as diary capable of leaving a note for the user information including a telephone number, an address, and an e-mail address and so forth prior to developing the portable terminal. A user increases more and more a case used to store in the portable terminal their information due to latest functions of the portable terminal, and confirm information stored in a note if needed.

However, while a user information storing method of the portable terminal provides convenience, if a user does not manage properly the user information, it may bring about many problems to use the user information.

That is, whenever a user of the portable terminal changes the user information and the user does not perform to an update process, the stored user information of the other in advance may become unnecessary information which does not work.

The above-mentioned problem is frequently occurred because of the increase in the information of users stored in the portable terminal in advance more and more and a situation where one is not able to directly confirm the user information change of the other.

However, the service to provide a changed user's contact information of the other in order to solve the above-mentioned problem provides, the above-mentioned service provides for only a predetermined period and does not provide a notice concerning the information change except for a telephone number.

Upon communicating with the other at an ending point of the service providing to change user's contact information of the other, there occurs a problem which is discontinued to communicate with a user of the other because the user does not confirm a changed user's contact information of the other.

### SUMMARY OF THE INVENTION

To address the above-discussed deficiencies of the prior art, it is an aspect of the present disclosure to provide an apparatus and method for automatically updating a user address book changed the other in a mobile communication system.

Another aspect of the present disclosure is to provide an apparatus and method for automatically updating an address book of a user which is registered to an update server in a portable terminal.

Still another aspect of the present disclosure is to provide an apparatus and method for requesting in order to automatically update a changed address book to a certain user in a portable terminal.

In accordance with an aspect of the present disclosure, an apparatus for downloading data in a portable terminal is provided. The apparatus includes a data update unit and a controller. The data update unit is configured to manage information associated with the portable terminal and a request for an address book update transmitted from the portable terminal. The controller is configured to receive changed address book information from an update server that manages an address book of another portable terminal in response to the request transmitted by the data update unit.

In accordance with another aspect of the present disclosure, a method of downloading data in a portable terminal is provided. The method includes updating data in a portable terminal. The method includes managing information associated with the portable terminal, transmitting a request for an address book update, and responsive to transmitting the request, receiving changed address book information from an update server that manages an address book of another portable terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain exemplary embodiments of the present disclosure will be more apparent from the following detailed description taken in conjunction with the accompanying drawings, in which:

FIG. 1 illustrates a mobile communication system for automatically updating changed address book information of a user according to the present disclosure;

FIG. 2 illustrates a process for automatically updating the personal information around a user in a portable terminal according to the present disclosure;

FIG. 3 illustrates a process for updating the personal information around a user in a portable terminal according to the present disclosure;

FIG. 4 illustrates a process for requesting an address book automatic update in a portable terminal according to the present disclosure;

FIG. 5 illustrates a process for automatically updating an address book of a portable terminal according to the present disclosure;

FIG. 6A illustrates a screen to automatically update a changed telephone number of a selected user in a portable terminal according to the present disclosure;

FIG. 6B illustrates a screen to automatically update a changed e-mail address of a selected user in a portable terminal according to the present disclosure;

FIG. 6C illustrates a screen to automatically update the notice information of a selected user in a portable terminal according to the present disclosure; and

FIG. 6D illustrates a screen to automatically update the notice information of a selected user in a portable terminal according to the present disclosure.

Throughout the drawings, like reference numerals will be understood to refer to like parts, components and structures.

### DETAILED DESCRIPTION OF THE INVENTION

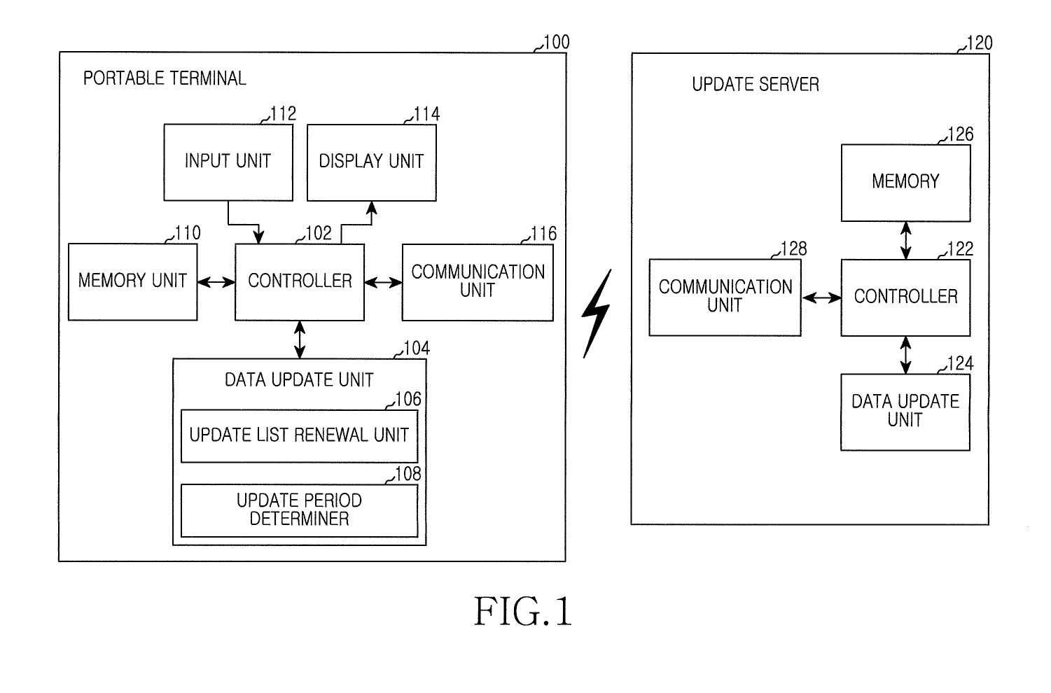

FIGS. 1 through 6D, discussed below, and the various embodiments used to describe the principles of the present disclosure in this patent document are by way of illustration only and should not be construed in any way to limit the scope of the disclosure.

Embodiments of the present disclosure will be described hereinafter with reference to the accompanying drawings. In the following description, well-known functions or constructions are not omitted detailed description in case that a detailed description is determined to obscure a major point of the disclosure.

The present disclosure described hereinafter relates to an apparatus and method for automatically updating a user's changed address book of the other in a portable terminal.

The address book to be automatically updated means personal information of a user including telephone number of a user (subscriber), an address, an e-mail address, a nick-name, a notice including a row, a notice, and an attached image and so forth in a portable terminal.

FIG. 1 illustrates a mobile communication system for automatically updating changed address book information of a user according to the present disclosure.

As shown in FIG. 1, the mobile communication system can be included a portable terminal 100 and an update server 120.

The portable terminal 100 includes a controller 102, a data update unit 104, a memory unit 110, an input unit 112, and a display unit 114. The data update unit 104 further includes an update list renewal unit 106 and an update period determiner 108.

The controller 102 of the portable terminal 100 controls the overall operation of the portable terminal 100. For example, the controller 102 performs the processing and the control for voice communication and data communication, in addition to a general function in accordance with the present disclosure. The controller 102 manages list of users transmitting an address book automatic update request, and determines stored information in advance and other information in personal information of users corresponding to the list.

After this time, the controller 102 lets a user change the stored information in advance into the latest changed personal information of users.

The data update unit 104 receives the changed information of users performed an address book automatic update request, and processes so as to update the stored information into the latest information by control of the controller 102.

The data update unit 104 manages users called for the address book automatic update, and processes so as to determine the time when a user identifies address book information of users.

The update list determiner 108 of the data update unit 104 manages items of users called for the address book automatic update by control of the data update unit 104.

The update period determiner 108 sets up the time when a user determines whether the address book about users is changed or not, and determines the time when a user changes the address book by control of the data update unit 104.

The memory unit 110 preferably includes, for example, a Read Only Memory (ROM), a Random Access Memory (RAM), a flash ROM, and such. The ROM stores a program code of a program for controlling the controller 102 and the data update unit 104, and all sorts of reference data.

The RAM is as a working memory of the controller 102, and stores temporary data generated while operating all sorts of programs. Also, the flash ROM stores telephone book, all sorts of data for storing updatable such as an originating message and a receiving message.

The input unit 112 includes a plurality of function keys such as number key buttons of 0 to 9, a menu button, a cancel button, a confirm button, a communication button, a close button, an Internet connecting button, navigation key (or direction key) buttons, and a plurality of character input keys and so forth, and provides key input data corresponding to a key pushed by a user to the controller 102.

The display unit 114 displays a state of information generated while operating the portable terminal, characters having limited numbers, plenty of video data, and still images and so forth. The display unit 114 can be used a color Liquid Crystal Display (LCD), Active Mode Organic Light Emitting Diode (AMOLED), and such.

The communication unit 116 performs a function to transmit and receive an RF signal inputted and outputted via the antenna (not illustrated). For example, when transmitting data, the communication unit 116 performs a transmitting function by processing RF after the communication unit 116 performs a channel coding and spreading of transmitting data, when receiving data, converts an RF signal into a baseband signal, and performs a function to de-spreading and channel decoding of the baseband signal, and to restore data.

The role of the data update unit 104 may be performed by the controller 102 of the portable terminal 100. To separately display data update unit 104 in the present disclosure is an exemplary structure for explanatory convenience but is not a limitation on the scope of the present disclosure. Various modifications of the structure may be implemented within the scope of the present disclosure by those skilled in the art. For example, all functions of the data update unit 104 may be performed by the controller 102.

The server controller 122 of the update server 120 performs the overall operation of the update server 120, when receiving the address book information confirm request in accordance with the present disclosure, searches the memory 126 and determines user's address book information including the request. At this time, the server controller 122 determines a new changed user's address book information of an address book stored in the memory 126, and can be provided the information to the portable terminal 100.

The role of the data update unit 124 manages an address book information of portable terminals, provides user's personal information meaning the personal information of a user including a user's (subscriber's) telephone number of the portable terminal 100, an address, an e-mail address, a nick-name, a notice, an attached image and so forth, and processes to store in the memory 126.

The memory 126 stores information associated with the operation of the update server 120. The information can be stored and managed address information of users in accordance with the present disclosure. The communication unit 128 can communicate with the portable terminal 100, receive address information from the portable terminal 100, and transmit changed address information to the portable terminal 100.

The role of the data update unit 124 can be performed by the server controller 122. However, to display the data update unit 124 separately in the present disclosure is an exemplary structure for explanatory convenience. This structure is not a limitation of the scope of the present disclosure. Various modifications of the structure can be implemented within the scope of the present disclosure by those skilled in the art. For example, the controller 122 can be capable of processing all of the above functions.

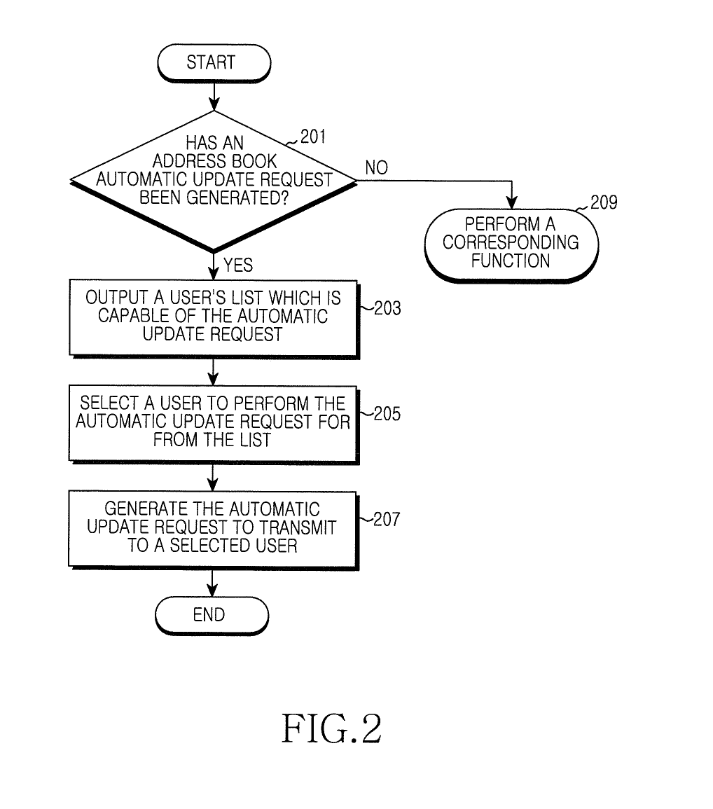

FIG. 2 illustrates a process for automatically updating the personal information around a user in a portable terminal according to the present disclosure.

Referring to FIG. 2, the portable terminal determines whether an address book automatic update request has been generated in step 201. Herein, the address book automatic update request means the request to automatically update a changed user's address book information to a selected user (another user) when changing a user's address book information used in the portable terminal.

Upon determining that the address book automatic update request was not generated in step 201, the portable terminal proceeds to step 209 and performs a corresponding function (e.g.; waiting mode).

On the other hand, upon determining to generate the address book automatic update request in step 201, the portable terminal proceeds to step 203 and outputs a user's list which is capable of an automatic update request.

Herein, the user's list capable of an automatic update request is a list of users to share the update of a changed address book (latest address book). The user's list can be a list of an address book stored in the portable terminal or a user's list which has transmitted and received the message of the portable terminal. The user's list can be directly selected to receive an automatic update request by a user.

After this time, the portable terminal selects a user to automatically update the changed address book when changing its address book in step 205. The portable terminal then processes so as to generate and transmit an automatic update request transmitting to the selected user in step 207.

As a result, even though a user of portable terminal according to the present disclosure changes his/her address book, the portable terminal processes so as to automatically update an address book in the terminal of other users who have made acquaintance with the user.

By the above-mentioned functions, a marketing staff manager who manages a personal connection, users who the term of a previous telephone number guide service before changing a telephone number expired, and/or a user who frequently changes his/her telephone number can be automatically registered a changed telephone number to a terminal of other user.

Hereinafter, the portable terminal stops this algorithm.

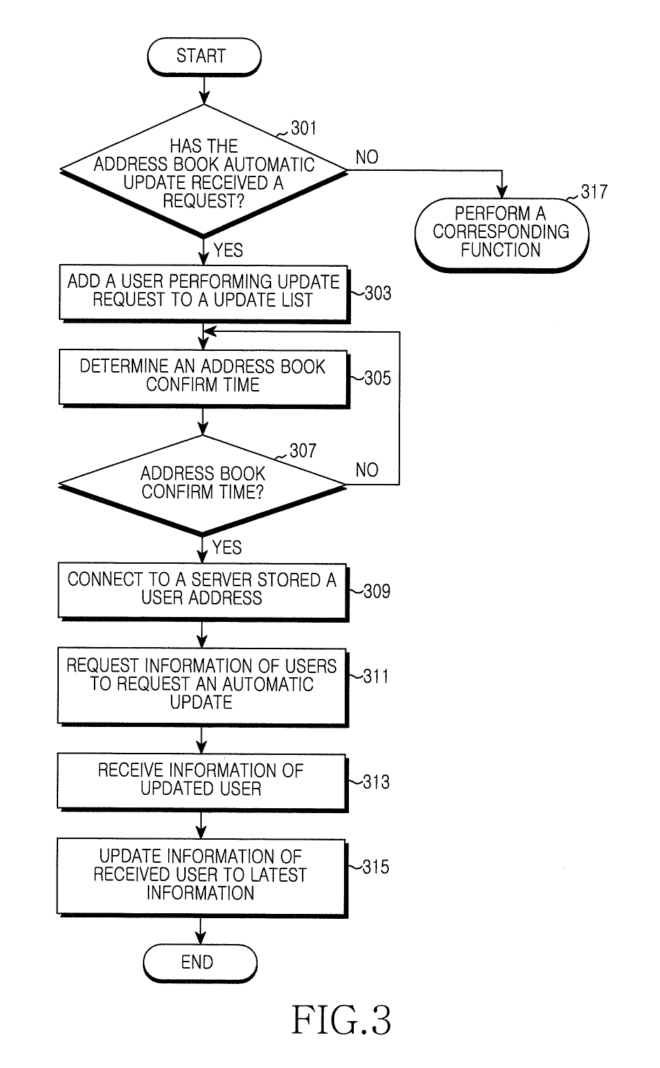

FIG. 3 illustrates a process for updating the personal information of a user in a portable terminal according to the present disclosure.

Referring to FIG. 3, first of all in step 301, the portable terminal determines whether the address book automatic update received a request.

Herein, the address book automatic update request means the request so as to update a one's address book when registering changed information to the update server after a user changed personal information such as, for example, an address book including a telephone number of a user (subscriber) of the portable terminal, an address, an e-mail address, a nick-name, a notice having a row, and a notice and so forth. Also, the update server connects to a server or HLR (Home Location Register) for managing an address book of a mobile communication subscriber, a notice, an e-mail address and such or comprises separately.

Upon determining that the address book automatic update request has not been received in step 301, the portable terminal makes progress to step 317, and performs a corresponding function (e.g.; waiting mode).

On the other hand, upon determining to generate the address book automatic update request in step 301, the portable terminal proceeds to step 303 and adds a user performing the update request to an update list. As the step 303 is to manage a user list allowed one's address update, the portable terminal can be updated the address book information of a user included in the list or can be updated the list by selecting a certain user and specifying an update time.

Thereafter, the portable terminal proceeds to step 305 and determines an address book confirm time of a user included in the list. Herein, as the user address book confirms time determines the time when the update information (the changed address book information) registered in the server receives, the portable terminal can be updated a changed personal information about user's friends by communicating with the update server in a period having a short time, reduced to generate the expense by communicating with the update server rather than the swift update of a changed personal information by communicating with the update server in a period having a long time.

Thereafter, the portable terminal proceeds to step 307, and determines whether the time is present to update the address book of a user included in the list. Upon determining what the time is not present to update the address book in step 307, the portable terminal performs the step 305 again.

On the other hand, the portable terminal proceeds to step 311 and calls for information of users (users including the managed list in the step 303) after proceeding to step 309 and connecting to the update server (update server to manage address book of a user) storing the user addresses.

Thereafter, the portable terminal proceeds to step 313 and receives updated user information. Herein, the 313 step means the process to receive changed information of users changed the address book information of the update server.

After this time, the portable terminal proceeds to step 315, and processes so as to update the address information of a user to the latest information by storing the address book of a changed user received from the update server.

After this time, the portable terminal stops this algorithm.

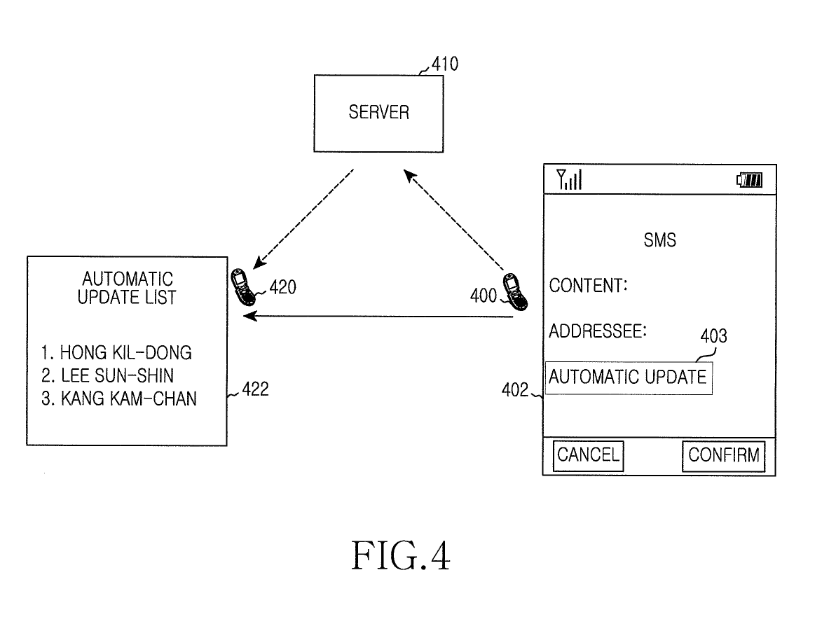

FIG. 4 illustrates a process for requesting an address book automatic update in a portable terminal according to the present disclosure.

Referring to FIG. 4, the portable terminal 400 will perform a request to automatically update changed information in address book of a portable terminal 420 of a user on an automatic update list 422.

As shown in FIG. 4, the request adds to an automatic update field 403 for activating the request in a text message 402, and sends the text message to a certain terminal, and performs a changed address book update. Above-mentioned process can be used between users (users located at a remote distance) which are unable to use the wireless communication via a message server 410.

Also, as shown in FIG. 4, the request can be directly performed by using the wireless communication (e.g.: Bluetooth, infrared light communication, and cable connection and the like) without transmitting via the message server 410.

The portable terminal 420 received the request processes so as to automatically update an address book of a user in a list after storing the list of user transmitting the automatic update request.

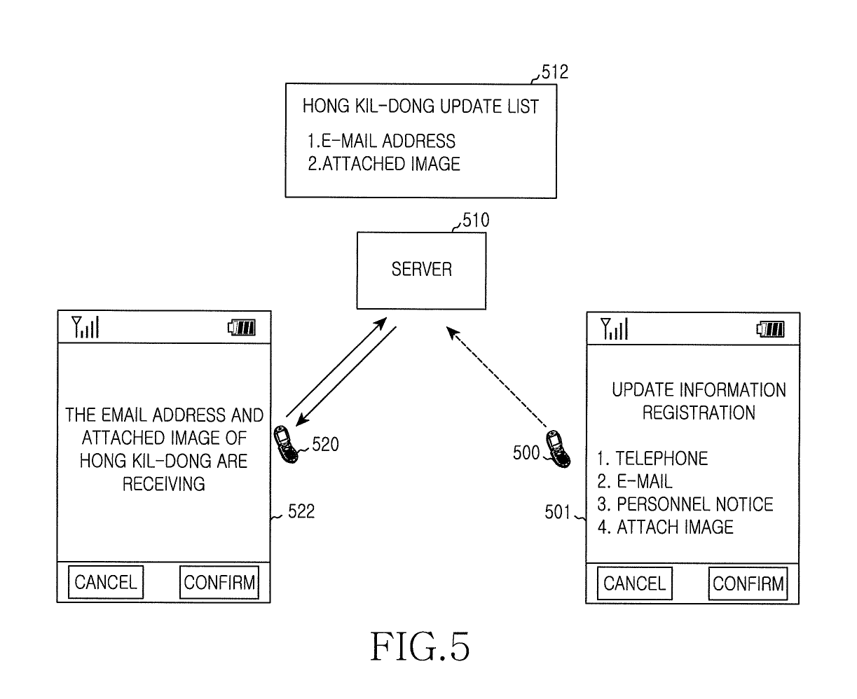

FIG. 5 illustrates a process for automatically updating an address book of a portable terminal according to the present disclosure.

Referring to FIG. 5, a user of the portable terminal 500 will update address book information. The update of the address book information 501 may be a contact number of a user, an e-mail address, a personal notice, and an image attachment. When the update process performs an update concerning at least one item of the above list, the portable terminal 500 transmits the changed item to an update server 510.

As a result, the update server 510 will perform an address book update process 512 to change address book information of a user into updated information.

If another portable terminal 520 receives the address book automatic update request for the portable terminal 500, the portable terminal 520 connects to the update server 510 on a predetermined time and requests the changed address book information of the portable terminal 500.

At this time, when the address book information of the portable terminal 500 has not changed, the portable terminal 520 will not receive information from the update server 510.

However, upon changing the address book information of the portable terminal 500, the portable terminal 520 will receive user address book information changed from the updated server 510.

For example, as shown 512 in FIG. 5, upon changing an e-mail address and an attached image of Hong Kil-Dong user, the portable terminal 520 will download the changed e-mail address and the changed attached image of user Hong Kil-Dong 522.

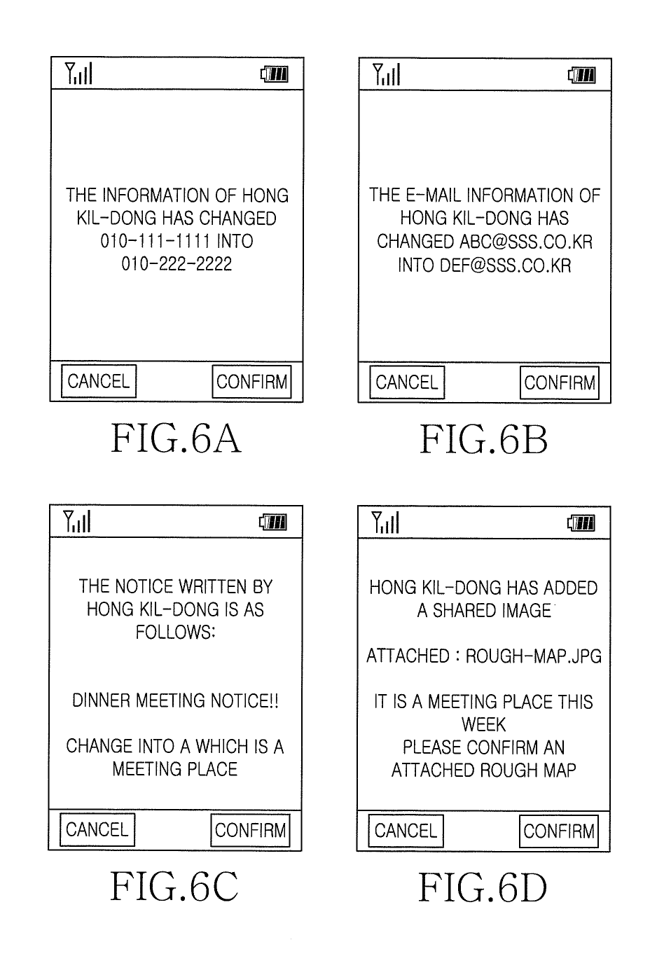

FIG. 6 illustrates a screen to automatically update a changed telephone number of a selected user in a portable terminal according to the present disclosure.

Referring to FIG. 6, upon changing the address book information such as a telephone number, an e-mail address, a notice, and attached image the portable terminal can be automatically stored in a selected user (The other user).

What the above changed address book information automatically store in the certain user terminal is because the portable terminal performs to call for the address book automatic update to the portable terminal.

The automatic update request is a request so as to receive the changed information to the update server when the above-mentioned items are changed. The portable terminal can be used to add to an additional item in a function to communicate with a receiving terminal such as an SMS message or an MMS message.

FIG. 6A illustrates a screen to automatically update a changed e-mail address of a selected user in a portable terminal according to the present disclosure.

Referring to FIG. 6A, if the portable terminal assumes a state received the automatic update request from Hong Kil-Dong who is a user of a different portable terminal, the portable terminal will request to determine whether an address book of the other users including a user Hong Kil-Dong has changed by connecting to the update server at a predetermined address book confirm time.

The update server receives the confirm request of the above changed address book, determines the changed address book of users including the request, and transmits the changed address book to the portable terminal.

For example, when the telephone number of Hong Kil-Dong changes “010-111-1111” into “010-222-2222”, as shown in FIG. 6A, the portable terminal receives information of a changed telephone number, and processes so as to update a new changed telephone number in telephone number of the portable terminal.

FIG. 6B illustrates a screen to automatically update a changed e-mail address of a selected user in a portable terminal according to the present disclosure.

Referring to FIG. 6B, as described the above-mentioned explanation, if the portable terminal receives the automatic update request from Hong Kil-Dong who is the other user, the portable terminal will perform a confirm request whether an address book of the other users including a user named “Hong Kil-Dong” has changed by connecting to the update server on a predetermined address book confirm time.

The update server receives the confirm request of the changed address book, determines a changed address book of users included in the list, and transmits the changed address book to the portable terminal.

For example, when an e-mail address of Hong Kil-Dong changes “ABC@SSS.co.kr” into “DEF@SSS.co.kr”, as shown in FIG. 6B, the portable terminal receives information of a changed e-mail address and processes so as to update a new changed e-mail address in personal information of the portable terminal.

FIG. 6C illustrates a screen to automatically update the notice information of a selected user in a portable terminal according to the present disclosure.

Referring to FIG. 6C, as described the above-mentioned explanation, if the portable terminal receives the automatic update request from Hong Kil-Dong who is the other user, the portable terminal will perform a confirm request whether an address book of the other users including a user named “Hong Kil-Dong” has changed by connecting to the update server on a predetermined address book confirm time.

The update server receives the confirm request of the changed address book, determines a changed address book of users included in the list, and transmits the changed address book to the portable terminal.

For example, when a user called Hong Kil-Dong registers a notice information, the portable terminal, as shown in FIG. 6C, the portable terminal receives the notice information registered, and notifies a user of the portable terminal know through the pop-up screen or processes so as to store the received notice information in a certain folder.

FIG. 6D illustrates a screen to automatically update the notice information of a selected user in a portable terminal according to the present disclosure.

Referring to FIG. 6D, as described the above-mentioned explanation, if the portable terminal receives the automatic update request from Hong Kil-Dong who is the other user, the portable terminal will perform a confirm request whether an address book of the other users including a user named “Hong Kil-Dong” has changed by connecting to the update server on a predetermined address book confirm time.

The update server receives the confirm request of the changed address book, confirms a changed address book of users included in the list, and transmits the changed address book to the portable terminal.

For example, when a user called Hong Kil-Dong registers an attached image, as shown in FIG. 6D, the portable terminal receives an attached image registered, and processes so as to store the attached image in a certain folder.

As described above, the present disclosure automatically updates the address book of users who the term of a service to let a user know a previous telephone number before changing the telephone number expired. Automatically updating the address books of a changed user to the update server is useful to a user who the management of a personal connection is important.

While the present invention has been particularly shown and described with reference to exemplary embodiments thereof, it will be understood by those skilled in the art that various changes in form and details may be made therein without departing from the spirit and the scope of the present invention as defined by the appended claims.

What is claimed is:

1. An apparatus for updating data in a portable terminal, the apparatus comprising:
a data update unit configured to manage information associated with the portable terminal and a request for an address book update transmitted from the portable terminal; and
a controller configured to receive changed address book information from an update server that manages an address book of another portable terminal in response to the request transmitted by the data update unit.

2. The apparatus of claim 1, wherein the controller is further configured to store the changed address book information in response to receiving the changed address book information.

3. The apparatus of claim 1, wherein the controller is further configured to receive the changed address book information at a predetermined period established in advance.

4. The apparatus of claim 1, wherein the controller is further configured to receive the changed address book information using at least one of a short message service (SMS) message and a multimedia messaging service (MMS) message.

5. The apparatus of claim 1, wherein the controller is further configured to receive the changed address book information using a wireless communication link.

6. The apparatus of claim 1, wherein the changed address book information includes at least one information of a user telephone, an address, an e-mail address, a nick-name, a memo including a row, a notice, and an attached image.

7. The apparatus of claim 1, wherein the controller is further configured to register an address book of the portable terminal to the update server and register a changed address book to the update server in response to the address book of the portable terminal changing.

8. A method of updating data in a portable terminal, the method comprising:
managing information associated with the portable terminal;
transmitting a request for an address book update; and
responsive to transmitting the request, receiving changed address book information from an update server that manages an address book of another portable terminal.

9. The method of claim 8 further comprising:
responsive to receiving the changed address book information, storing the changed address book information.

10. The method of claim 8, wherein the changed address book information is received at a predetermined period established in advance.

11. The method of claim 8, wherein the changed address book information is received by at least one of a short message service (SMS) message and a multimedia messaging service (MMS) message.

12. The method of claim 8, wherein the changed address book Information is received using a wireless communication link.

13. The method of claim 8, wherein the changed address book information includes at least one information of a user telephone, an address, an e-mail address, a nick-name, a memo including a row, a notice, and an attached image.

14. The method of claim 8 further comprising:
registering an address book of the portable terminal to the update server; and
responsive to information in the address book of the portable terminal changing, registering a changed address book to the update server.

15. A system for updating data in a portable terminal, the system comprising:
a storage device storing program code; and
a controller configured to process the program code to manage information associated with the portable terminal, transmit a request for an address book update, and receive, responsive to transmitting the request, changed address book information from an update server that manages an address book of another portable terminals.

16. The system of claim 15, wherein the controller is further configured to store, responsive to receiving the changed address book information, the changed address book information.

17. The system of claim 15, wherein the changed address book information is received at a predetermined period established in advance.

18. The system of claim 15, wherein the changed address book information is received by at least one of a short message service (SMS) message and a multimedia messaging service (MMS) message.

19. The system of claim 15, wherein the changed address book Information is received using a wireless communication link.

20. The system of claim 15, wherein the changed address book information includes at least one information of a user telephone, an address, an e-mail address, a nick-name, a memo including a row, a notice, and an attached image.
